(19) United States
(12) Patent Application Publication
(10) Pub. No.: US 2013/0145914 A1
(43) Pub. Date: Jun. 13, 2013

(54) CRANK SCISSORS HAVING TWO PAIRS OF BLADES FOR CUTITNG ROLLING STRIPS

(71) Applicant: SMS SIEMAG AKTIENGESELLSCHAFT, Dusseldorf (DE)

(72) Inventors: Gerhard HEITZE, Netphen (DE); Ulrich GREBE, Wenden (DE); Klaus BÄUMER, Kreuztal (DE)

(73) Assignee: SMS SIEMAG AKTIENGESELLSCHAFT, DUSSELDORF (DE)

(21) Appl. No.: 13/764,475

(22) Filed: Feb. 11, 2013

Related U.S. Application Data
(63) Continuation of application No. 10/538,970, filed on Jun. 14, 2005, now abandoned.

(30) Foreign Application Priority Data
Dec. 17, 2002 (DE) 102 58 887.2

(51) Int. Cl. B23D 17/06

(52) U.S. Cl. CPC B23D 17/06
USPC 83/599

(57) ABSTRACT

Crank scissors, especially for cutting rolling strips, having two pairs of blades which can be secured to the blade carriers. The blade carriers are arranged in an opposite position on a vertical plane in a pair of eccentric drive shafts. Double-joint arrangements are maintained in a pivotable manner on torque-supporting levers co-operating with hydraulic control units that engage the levers. The blade carriers form pairs of heating surfaces, which are parallel to the axis, for the pairs of blades on approximately radial projections. The upper pair of blades is arranged on the inner, bearing surfaces of an arc-shaped recess of the upper blade carrier which are oriented towards each other, and the lower pair of blades is arranged on a relatively narrow projection on the outer bearing surfaces.

### CROSS-REFERENCE TO RELATED APPLICATIONS

The present application is a Continuation Application of U.S. patent application Ser. No. 10/538,970, filed Jun. 14, 2005, which is a 371 of International application PCT/EP2003/014225, filed Dec. 15, 2003, which claims priority of DE 102 58 887.2, filed Dec. 17, 2002, the priority of these applications is hereby claimed and these applications are incorporated herein by reference.

### BACKGROUND OF THE INVENTION

The invention concerns a crank shear, especially for cutting rolled strip, which comprises two pairs of blades that can be mounted on blade holders, wherein the blade holders are supported opposite each other in a vertical plane in a pair of eccentric drive shafts and are pivoted on torque supporting levers in double-joint mechanisms in interaction with hydraulic control units that act on these double-joint mechanisms.

Widely used crank shears have the disadvantage that they have only one pair of blades, usually with a convex cutting edge. Rotary shears used for the same application are known from the prior art, which have two pairs of blades, each of which has one convex and one concave cutting edge. In this regard, to achieve the ability to have a greater influence on the strip ends, the leading end of the strip is cut, for example, with a convex blade cutting edge, while the tail end of the strip is cut with a concave blade cutting edge.

The document EP 0 075 448 describes a crank shear with two pairs of blades which are supported opposite each other in a vertical plane in a pair of eccentric drive shafts and are pivoted on torque supporting levers in double-joint mechanisms with at least one hydraulic control unit that acts on these double-joint mechanisms.

The previously known shear for cutting metal strip has two blade holders, which can be rotated relative to each other, so that the blades can be alternately brought by their two blade holders into cutting positions with the metal strip. Each blade holder has a mounting for two blades and can be moved between two positions, in which the corresponding blades can each be brought into an operating position.

With this arrangement, one pair of blades at a time can be sharpened, while the other pair is used for cutting, and then both pairs can possibly be exchanged for one another.

A disadvantage of the previously known crank shear with two pairs of blades is the passage position of extremely small width that can be occupied between the pairs of blades, which, for example, during the passage of an upwardly bent leading end of a strip, can result in collision with the shear. A disruption of this type costs operating time and material. Another difficulty with the previously known shear is that the blades cannot be mounted in the blade holders with the provenly effective blade guard clamp.

The document EP 0 075 448 A discloses a crank shear with two pairs of blades that can be mounted on blade holders. The pairs of blades can be brought into a cutting position or into a maintenance position by means of a double-joint mechanism. The cutting position or the maintenance position is set by means of actuating cylinders that act on the corresponding double-joint mechanism. This document does not address the question of how a safe position for the passage of upwardly bent rolled strip can be reached.

### SUMMARY OF THE INVENTION

Proceeding on the basis of the aforementioned prior art, the objective of the invention is to specify a design of the crank shear with two pairs of blades that avoids the aforementioned problems and disadvantages and, in particular, allows a significantly wider passage position for the rolled strip and also allows the use of the proven blade guard clamp without any difficulties.

In this regard, one embodiment of the invention provides that in a spread position of the torque supporting levers of approximately 90° and at the shortest separation of the eccentric shafts and a running direction of the rolled strip towards the supporting levers, a position of the pair of blades is reached for the cropping cut at the leading end of the strip, in which the hydraulic control unit on the upper supporting lever of the double-joint mechanism is fully extended, and the hydraulic control unit on the lower supporting lever of the double-joint mechanism is fully retracted.

In addition, the invention provides that in an approximately horizontal parallel position of the torque supporting levers opposite the running direction of the rolled strip and at the shortest separation of the eccentric shafts, and with the upper and lower double-joint mechanism extended approximately linearly, a position of the rear pair of blades for cutting the tail end of the strip is reached, in which the hydraulic control unit on the upper supporting lever of the double-joint mechanism is fully retracted, and the control unit on the lower supporting lever of the double-joint mechanism is fully extended.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawing:

FIG. 1 shows a side view of the crank shear with two blade holders and blades mounted on them in an operating phase during the cropping of the leading end of a rolled strip.

FIG. 2 shows the crank shear in its extremely wide-open position for the passage of the rolled strip.

FIG. 3 shows the crank shear, likewise in a side view, in a position for cropping the tail end of the strip.

FIG. 4 shows the crank shear in its open position for another passage of the rolled strip following the cropping of the tail end of the strip.

### DETAILED DESCRIPTION OF THE INVENTION

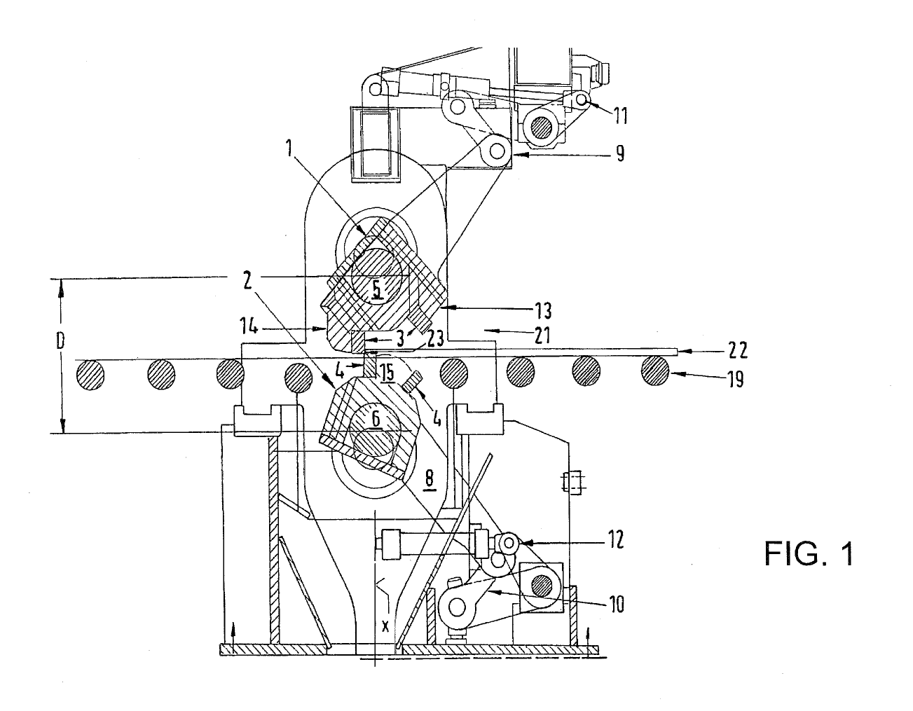

FIG. 1 shows the crank shear with two pairs of blades 3, 4, which can be mounted on blade holders 1, 2, wherein the blade holders 1, 2 are supported opposite each other in a vertical plane (x-x) in a pair of eccentric drive shafts 5, 6 and are pivoted on torque supporting levers 7, 8 in double-joint mechanisms 9, 10 and interact with hydraulic control units 11, 12 that act on these double-joint mechanisms.

The blade holders 1, 2 form axially parallel pairs of bearing surfaces 16 to 18 for the pairs of blades 3, 4 on approximately radial projections 13 to 15, with the upper pair of blades 3 arranged on inner, oppositely oriented bearing surfaces 16, 17 of a curved recess 20 of the upper blade holder 1, and with the lower pair of blades 4 arranged on the outer bearing surfaces 18 of a relatively narrow projection 15 oriented towards the recess 20.

In a spread position of the torque supporting levers 7, 8 of approximately 90° and at the shortest separation D of the eccentric shafts 5, 6 and a running direction 21 of the rolled strip 22, the crank shear has reached a position of the pair of blades 3 for the cropping cut at the leading end 23 of the strip. In this position, the hydraulic control unit 11 on the upper supporting lever 7 of the double-joint mechanism 9 is fully extended to spread the supporting lever 7, and the control unit 12 on the lower supporting lever 8 of the double-joint mechanism 10 is fully retracted. Reference number 19 identifies the roller table for conveying the rolled strip 22.

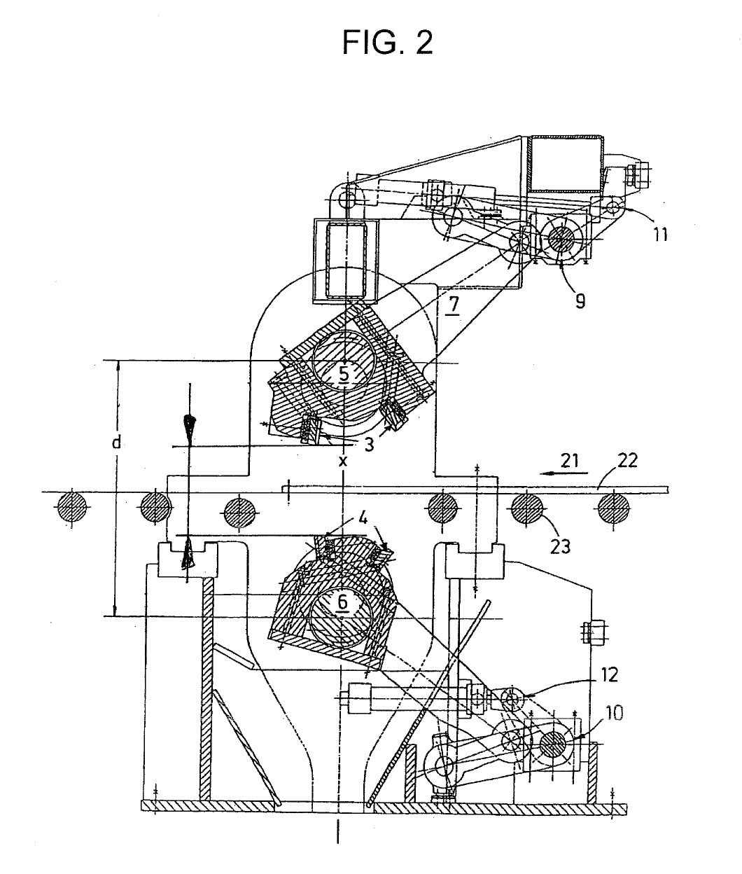

FIG. 2 shows a wide passage position of the crank shear for the rolled strip in an extreme spread position of the torque supporting levers 7, 8 of approximately 90° at the greatest separation d of the eccentric shafts 5, 6 and with a running direction 21 of the rolled strip 22 towards the supporting levers 7, 8. In this position, the control unit 12 on the lower supporting lever 8 of the double-joint mechanism 10 is fully retracted for its folding the lower supporting lever 8, and the control unit 11 on the upper supporting lever 7 of the double-joint mechanism 9 is fully extended.

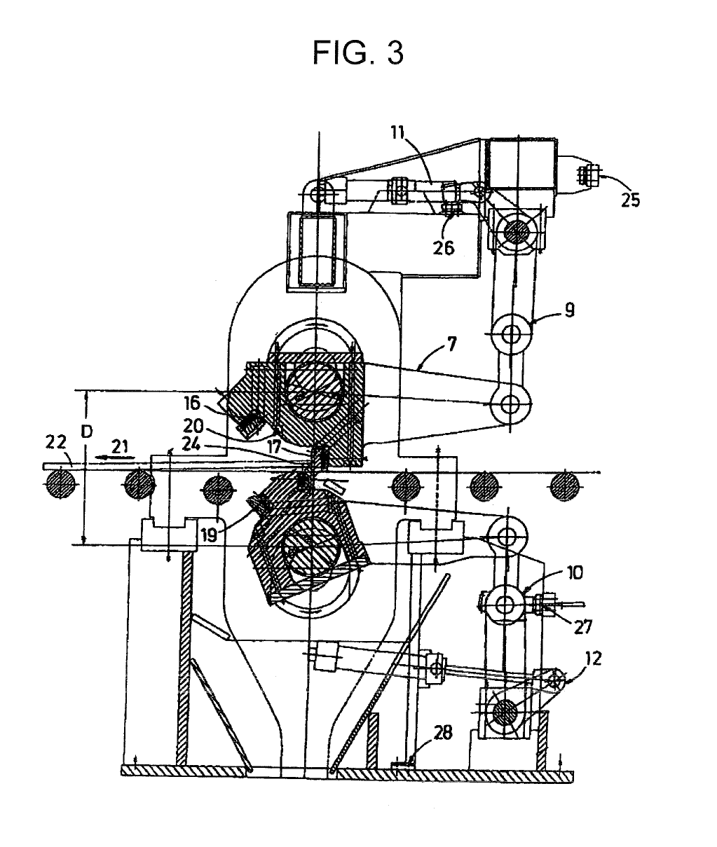

FIG. 3 shows the crank shear with an approximately horizontal parallel position of the torque supporting levers 7, 8 opposite the running direction 21 of the rolled strip 22 and at the shortest separation D of the eccentric shafts 5, 6, and with the upper double-joint mechanism 9 and lower double-joint mechanism 10 extended approximately linearly. A position of the rear pair of blades for cutting the tail end 24 of the strip is reached here. In this position, the hydraulic control unit 11 on the upper supporting lever 7 of the double-joint mechanism 9 is fully retracted, and the control unit 12 on the lower supporting lever 8 of the double-joint mechanism 10 is fully extended.

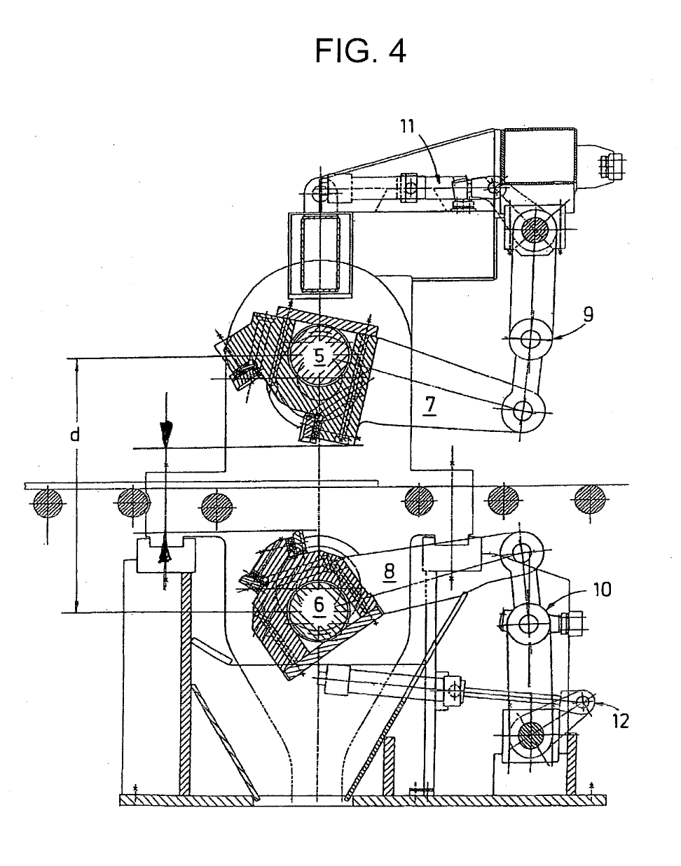

Finally, FIG. 4 shows a passage position through the shear with the eccentric shafts 5, 6 at their greatest separation. Here the upper hydraulic control unit 11 of the upper double-joint mechanism 9 is fully retracted in a position of the upper supporting lever 7 that is downwardly inclined, while the lower control unit 12 of the lower double-joint mechanism 10 is fully extended.

While specific embodiments of the invention have been shown and described in detail to illustrate the inventive principles, it will be understood that the invention may be embodied otherwise without departing from such principles.

We claim:

1. Crank shear, especially for cutting rolled strip, which comprises two pairs of blades that can be mounted on blade holders, wherein the blade holders are supported opposite each other in a vertical plane in a pair of eccentric drive shafts and are pivoted on torque supporting levers in double-joint mechanisms in interaction with two hydraulic control units that act on these double-joint mechanisms, wherein the blade holders form axially parallel pairs of bearing surfaces for the pairs of blades on approximately radial projections, with the upper pair of blades arranged on inner, facing bearing surfaces of a curved recess of the upper blade holder, and with the lower pair of blades arranged only on outer, oppositely directed bearing surfaces of a projection oriented towards the recess, the projection being relatively smaller and formed as a single piece with the lower blade holder, each blade of the lower pair of blades having a completely exposed surface facing away from the other blade of the lower pair of blades, wherein the completely exposed surface is an entire face of the blade, each of the blades of the lower pair of blades being independently attached to the lower blade holder, wherein the upper blade holder and the lower blade holder are of non-identical construction.

2. Crank shear in accordance with claim 1, wherein in a spread position of the torque supporting levers of approximately 90° and at the shortest separation of the eccentric shafts and a running direction of the rolled strip towards the supporting levers, a position of the pair of blades for the cropping cut at the leading end of the strip is reached, in which the hydraulic control unit on the upper supporting lever of the double-joint mechanism is fully extended, and the control unit on the lower supporting lever of the double-joint mechanism is fully retracted.

3. Crank shear in accordance with claim 1, wherein, in a spread position of the torque supporting levers of approximately 90° and at the greatest separation of the eccentric shafts and a running direction of the rolled strip towards the supporting levers, a passage position of the crank shear is reached, in which the control unit on the lower supporting lever of the double-joint mechanism is fully retracted, and the control unit on the upper supporting lever of the double-joint mechanism is fully extended.

4. Crank shear in accordance with claim 1, wherein in an approximately horizontal parallel position of the torque supporting levers opposite the running direction of the rolled strip and at the shortest separation of the eccentric shafts, and with the upper double-joint mechanism and lower double-joint mechanism extended approximately linearly, a position of the rear pair of blades for cutting the tail end of the strip is reached, in which the hydraulic control unit on the upper supporting lever of the double-joint mechanism is fully retracted, and the control unit on the lower supporting lever of the double-joint mechanism is fully extended.

5. Crank shear in accordance with claim 1, wherein, in a position of the upper supporting lever that is downwardly inclined towards the rolled strip with the upper hydraulic control unit of the double-joint mechanism retracted, and in a position of the lower supporting lever that is upwardly inclined towards the rolled strip with the lower control unit of the double-joint mechanism fully extended, and with the greatest separation of the eccentric shafts, the passage position through the shear is reached.
